(19) United States
(12) Patent Application Publication
(10) Pub. No.: US 2026/0194016 A1
(43) Pub. Date: Jul. 9, 2026

(54) FUEL GAS SUPPLY DEVICE

(71) Applicant: MITSUBISHI HEAVY INDUSTRIES, LTD., Tokyo (JP)

(72) Inventors: Rei IKEDA, Tokyo (JP); Yoshikazu UEKI, Tokyo (JP); Masahiko NAKAHARA, Tokyo (JP); Yutaka KUBOTA, Tokyo (JP)

(21) Appl. No.: 19/132,240

(22) PCT Filed: Nov. 28, 2023
(86) PCT No.: PCT/JP2023/042512

§ 371 Date: May 22, 2025

(30) Foreign Application Priority Data
Dec. 19, 2022 (JP) 2022-201835

(51) Int. Cl. F02C 9/26; F02C 7/232; F23R 3/28

(52) U.S. Cl. CPC F02C 9/263; F02C 7/232; F23R 3/28

(57) ABSTRACT

A fuel gas supply device for supplying fuel gas to a plurality of fuel nozzles provided in a combustor of a gas turbine. This device is provided with: a shutoff valve provided upstream of a plurality of flow rate regulating valves for regulating a flow rate of fuel gas to be supplied to each fuel nozzle; a shutoff-valve bypassing valve provided in a bypass line provided to bypass the shutoff valve; and a control device for controlling an upstream side pressure of the flow rate regulating valve. In a normal operation time, the shutoff-valve bypassing valve is closed while the shutoff valve is opened, whereby an upstream side pressure is controlled by a supply pressure of a fuel gas supply source. In at least one of an ignition time and a speed raising time of a gas turbine, the shutoff-valve bypassing valve is opened while the shutoff valve is closed.

### TECHNICAL FIELD

The present disclosure relates to a fuel gas supply device for supplying a fuel gas to a combustor of a gas turbine.

The present application claims priority based on Japanese Patent Application No. 2022-201835 filed in Japan on Dec. 19, 2022, the contents of which are incorporated herein by reference.

### BACKGROUND ART

In a gas turbine, a turbine is driven by a combustion gas generated by combusting a fuel in a combustor. A combustor is provided with a fuel nozzle for ejecting a fuel gas into a combustion chamber, and in particular, a combustor including a plurality of types of fuel nozzles for the purpose of reducing an NOx discharge amount or improving combustion stability is known. For example, in PTL 1, as such a fuel nozzle, a combustor including a top hat nozzle for premixed combustion for the purpose of further reducing the NOx discharge amount in addition to a main nozzle for premixed combustion and a pilot nozzle for diffusion combustion is targeted, and a technique related to fuel gas supply control is disclosed.

In a case where there are a plurality of types of fuel nozzles, which are supply destinations, in a fuel gas supply device for supplying a fuel gas to a combustor, the fuel gas supply device may be configured to independently control a supply amount of the fuel gas for each type. For example, in the configuration of PTL 1, each of the supply systems for supplying the fuel gas to the various fuel nozzles is provided with a pressure regulation valve and a flow rate regulation valve in order from an upstream side of the flow of the fuel gas. The pressure regulation valve has a function of maintaining a constant differential pressure between an upstream side and a downstream side of the flow rate regulation valve. Accordingly, the flow rate regulation valve is capable of adjusting the flow rate of the fuel gas in the non-choke flow region by performing opening degree control such that the opening degree reaches the target opening degree obtained by the calculation based on the flow rate coefficient (Cv value) of the flow rate regulation valve under the condition that the differential pressure is constant.

In the configuration of the fuel gas supply device disclosed in PTL 1, the pressure regulation valve and the flow rate regulation valve, which are hydraulic drive valves, are respectively provided in each supply system provided for each type of fuel nozzle. The hydraulic drive valve has high costs for a control valve, a control oil system, or the like. Therefore, it is conceivable to reduce costs by using an air drive valve instead of the hydraulic drive valve, but the air drive valve is inferior in responsiveness and positioning accuracy compared to the hydraulic drive valve. Therefore, when an air drive valve is adopted for the pressure regulation valve, there is a concern that the upstream pressure of the flow rate regulation valve may fluctuate and the flow rate controllability may be deteriorated.

In order to solve such problems, in PTL 2, by operating the flow rate regulation valve in the choke flow region, it is possible to omit the pressure regulation valve from each supply system provided for each type of fuel nozzle, and to reduce costs by reducing the number of valves. In general, when the downstream pressure is gradually decreased while the upstream state is fixed in the pipe channel through which the compressible fluid flows, the flow rate in the pipe channel increases as the downstream pressure decreases because the flow is initially in a non-choke flow region. However, when the downstream pressure decreases to a predetermined pressure or less, the flow is in a choke flow region where the flow rate does not change (that is, in the choke flow region, the flow rate does not depend on the downstream pressure and depends only on the upstream pressure).

The choke flow region is defined as a region where the upstream pressure Pin and the downstream pressure Pout of the flow rate regulation valve satisfy the following relationship.

$$Pout \leq Pin / 2 \qquad ( 1 )$$

### CITATION LIST

### Patent Literature

[PTL 1] Japanese Unexamined Patent Application Publication No. 2007-77867
[PTL 2] International Publication No. WO2013/105406

### SUMMARY OF INVENTION

### Technical Problem

In PTL 2, the target opening degree of the flow rate regulation valve can be calculated by using the upstream pressure and the required flow rate by operating the flow rate regulation valve in the choke flow region. Therefore, the number of valves can be reduced and the cost can be reduced by eliminating the need for the pressure regulation valve. Since such a configuration is assumed to be during the normal operation in which the flow rate of the fuel gas is sufficiently high, the flow rate coefficient (Cv value) of the flow rate regulation valve may decrease and the accuracy of the flow rate control of the fuel gas may decrease at the time of ignition or increase in speed of the gas turbine, in which the flow rate of the fuel gas is relatively low.

As a method for solving such a problem, for example, it is conceivable to configure the flow rate regulation valves of the each of the supply systems provided for each type of the fuel nozzle with a main valve and a small valve having different flow rate coefficients from each other, and to switch the main valve and the small valve in accordance with the flow rate of the fuel gas. In this case, the main valve is used during the normal operation in which the flow rate of the fuel gas is relatively high, and the sub-valve is used at the time of ignition or increase in speed in which the flow rate of the fuel gas is relatively low. In this manner, the flow rate coefficient (Cv value) of the flow rate regulation valve can be appropriately secured in each operation state. However, configuring the flow rate regulation valve provided for each type of fuel nozzle in this manner still leads to an increase in the number of valves.

At least one embodiment of the present disclosure has been made in view of the above-described circumstances, and an object of the present disclosure is to provide a fuel gas supply device in which the flow rate control of a fuel gas with respect to various fuel nozzles at the time of ignition or increase in speed of a gas turbine can be accurately performed with a simple configuration.

### Solution to Problem

In order to solve the above-described problems, a fuel gas supply device according to at least one embodiment of the present disclosure is
a fuel gas supply device for supplying a fuel gas to a plurality of fuel nozzles provided in a combustor of a gas turbine, the fuel gas supply device including:
a fuel gas supply system for supplying the fuel gas to each of the plurality of fuel nozzles via a fuel gas supply line connected to a fuel gas supply source;
a plurality of flow rate regulation valves provided in the fuel gas supply line and for regulating a flow rate of the fuel gas to each of the plurality of fuel nozzles;
a shutoff valve provided on an upstream side of the plurality of flow rate regulation valves in the fuel gas supply line;
a bypass line provided to bypass the shutoff valve with respect to the fuel gas supply line;
a shutoff valve bypass valve provided in the bypass line; and
a control device for controlling an upstream pressure of the plurality of flow rate regulation valves in the fuel gas supply line, in which
the control device
   controls the upstream pressure using a supply pressure of the fuel gas supply source by opening the shutoff valve and closing the shutoff valve bypass valve in a case where the gas turbine is in a normal operation state, and
   controls the upstream pressure to be lower compared to the normal operation by closing the shutoff valve and opening the shutoff valve bypass valve in a non-normal operation state including at least one of the time of ignition or increase in speed of the gas turbine.

### Advantageous Effects of Invention

According to at least one embodiment of the present disclosure, it is possible to provide a fuel gas supply device in which the flow rate control of a fuel gas with respect to various fuel nozzles at the time of ignition or increase in speed of a gas turbine can be accurately performed with a simple configuration.

### BRIEF DESCRIPTION OF DRAWINGS

FIG. 1 is a schematic configuration diagram of a gas turbine power generation plant according to one embodiment.

FIG. 2 is a schematic configuration diagram of a fuel gas supply device in FIG. 1.

FIG. 3 is a block diagram showing a functional configuration of a control device in FIG. 1.

FIG. 4 is a flowchart showing a gas turbine control method according to one embodiment.

FIG. 5 is a schematic configuration diagram of a shutoff valve unit in FIG. 2.

FIG. 6A is a configuration diagram of a shutoff valve unit according to a first reference technique.

FIG. 6B is a configuration diagram of the shutoff valve unit according to the first reference technique.

FIG. 7 is a configuration diagram of a shutoff valve unit according to a second reference technique.

FIG. 8 is a schematic diagram showing an operation state of the shutoff valve unit in FIG. 5 in a non-normal operation state (for example, at the time of ignition or increase in speed).

FIG. 9 is a schematic diagram showing an operation state of the shutoff valve unit in FIG. 5 in an abnormality occurrence state.

### DESCRIPTION OF EMBODIMENTS

Hereinafter, some embodiments of the present invention will be described with reference to the accompanying drawings. Meanwhile, configurations described in the embodiments or shown in the drawings are not intended to limit the scope of the present invention, and are merely examples for description.

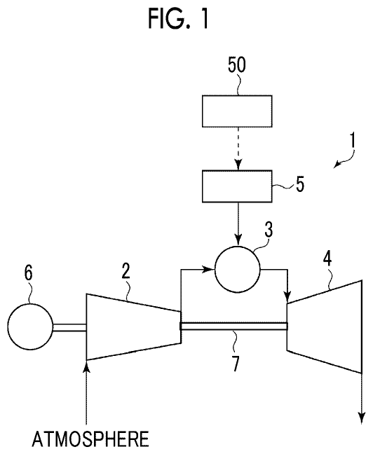

FIG. 1 is a schematic configuration diagram of a gas turbine power generation plant 1 according to one embodiment. The gas turbine power generation plant 1 includes a compressor 2, a combustor 3, a turbine 4, a fuel gas supply device 5, a generator 6, and a control device 50.

The compressor 2 is configured to suck air (atmosphere) from the outside to generate compressed air. The compressed air generated by the compressor 2 is supplied to the combustor 3. The combustor 3 generates high-temperature combustion gas by mixing the compressed air supplied from the compressor 2 with a fuel gas, which is a fuel supplied from the fuel gas supply device 5, and combusting the mixture. The turbine 4 receives the supply of the combustion gas generated by the combustor 3 and is driven to output a rotational driving force from the rotary shaft 7. The rotary shaft 7 transmits the rotational driving force output from the turbine 4 to the generator 6, and as a result, the generator 6 generates power.

The control device 50 is configured to control the fuel gas supply device 5 described above. Details of the control device 50 will be described in detail.

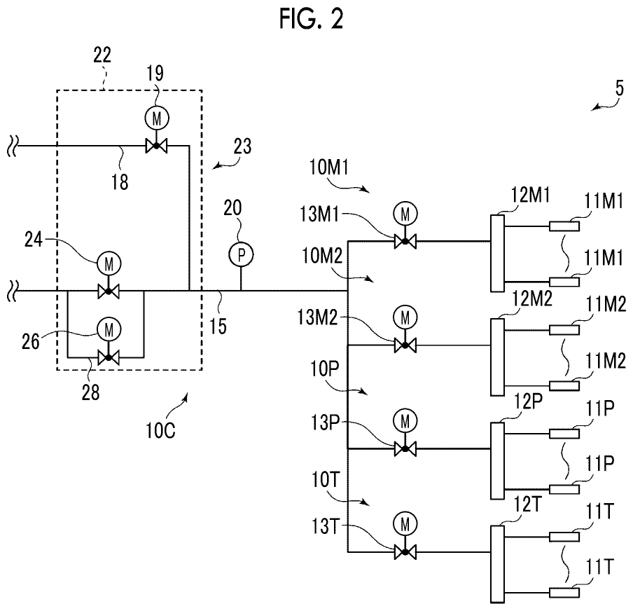

Next, a specific configuration of the fuel gas supply device 5 will be described with reference to FIG. 2. FIG. 2 is a schematic configuration diagram of a fuel gas supply device 5 in FIG. 1. The fuel gas supply device 5 is configured to supply a fuel gas, which is a fuel, to the combustor 3.

The fuel gas supply device 5 is configured to supply the fuel gas to the fuel nozzle provided in the combustor 3. The combustor 3 may include a plurality of types of fuel nozzles. In the present embodiment, the combustor 3 includes, as the fuel nozzles, a first main nozzle 11M1 and a second main nozzle 11M2 for premixed combustion for the purpose of reducing NOx, a pilot nozzle 11P for diffusion combustion for the purpose of stabilizing combustion, and the top hat nozzle 11T, which is a fuel nozzle for premixed combustion for the purpose of further reducing NOx. As the configuration of the combustor 3 including the various fuel nozzles, for example, a known configuration such as the configuration disclosed in Japanese Unexamined Patent Application Publication No. 2007-77867 can be used, and is not particularly limited.

The fuel gas supply device 5 includes a common system 10C, a first main fuel supply system 10M1, a second main fuel supply system 10M2, a pilot fuel supply system 10P, and a top hat fuel supply system 10T.

The common system 10C is a system for supplying a fuel gas to each of the first main fuel supply system 10M1, the second main fuel supply system 10M2, the pilot fuel supply system 10P, and the top hat fuel supply system 10T, and includes a fuel gas supply line 15. One end side of the fuel gas supply line 15 is connected to a fuel gas supply source (not shown) that is a supply source of the fuel gas, and the other end side of the fuel gas supply line 15 is branched and connected to the first main fuel supply system 10M1, the second main fuel supply system 10M2, the pilot fuel supply system 10P, and the top hat fuel supply system 10T.

A shutoff valve unit 22 is provided in the fuel gas supply line 15. Although a detailed configuration of the shutoff valve unit 22 will be described later, the shutoff valve unit 22 is configured to include a plurality of valves including the shutoff valve 24 for shutting off the fuel gas flowing through the fuel gas supply line 15. The shutoff valve 24 is provided in the fuel gas supply line 15 and can switch between open/closed states (that is, the shutoff valve 24 is a valve that can switch between two stages in which the opening degree is “0%” or “100%”).

In addition, the shutoff valve unit 22 includes a bypass line 28 that bypasses the shutoff valve 24 with respect to the fuel gas supply line 15, and a shutoff valve bypass valve 26 provided in the bypass line 28. The shutoff valve bypass valve 26 is a valve configuration in which the opening degree can be adjusted between “0%” and “100%”.

In addition, the shutoff valve unit 22 has a fuel gas discharge line 18 for discharging the fuel gas to the outside when the fuel gas flowing through the fuel gas supply line 15 is shut off by the shutoff valve 24 or the shutoff valve bypass valve 26. The fuel gas discharge line 18 is provided with a vent valve 19 for regulating the flow rate of the fuel gas to be discharged to the outside.

A pressure sensor 20 for measuring a first pressure P1, which is an upstream pressure of each of the flow rate regulation valves (the first main flow rate regulation valve 13M1, the second main flow rate regulation valve 13M2, the pilot flow rate regulation valve 13P, and the top hat flow rate regulation valve 13T), is provided on a downstream side of the shutoff valve unit 22 in the fuel gas supply line 15.

The first main fuel supply system 10M1 is a system for supplying a fuel gas to the first main nozzle 11M1. One end side of the first main fuel supply system 10M1 is connected to the fuel gas supply line 15 of the common system 10C, and the other end side of the first main fuel supply system 10M1 is connected to a first main manifold 12M1 for supplying the fuel gas to each of the first main nozzles 11M1. Further, the first main fuel supply system 10M1 is provided with a first main flow rate regulation valve 13M1 for controlling the flow rate of the fuel gas supplied to the first main nozzle 11M1. The first main flow rate regulation valve 13M1 is a valve for regulating the flow rate of the fuel gas supplied to the first main nozzle 11M1. The first main manifold 12M1 is configured to distribute the fuel gas supplied from the first main fuel supply system 10M1 to the plurality of first main nozzles 11M1.

The second main fuel supply system 10M2 is a system for supplying a fuel gas to the second main nozzle 11M2. One end side of the second main fuel supply system 10M2 is connected to the fuel gas supply line 15 of the common system 10C, and the other end side of the second main fuel supply system 10M2 is connected to a second main manifold 12M2 for supplying the fuel gas to each of the second main nozzles 11M2. Further, the second main fuel supply system 10M2 is provided with a second main flow rate regulation valve 13M2 for controlling the flow rate of the fuel gas supplied to the second main nozzle 11M2. The second main flow rate regulation valve 13M2 is a valve for regulating the flow rate of the fuel gas supplied to the second main nozzle 11M2. The second main manifold 12M2 is configured to distribute the fuel gas supplied from the second main fuel supply system 10M2 to the plurality of second main nozzles 11M2.

The pilot fuel supply system 10P is a system that supplies a fuel gas to the pilot nozzle 11P. One end side of the pilot fuel supply system 10P is connected to the fuel gas supply line 15 of the common system 10C, and the other end side of the pilot fuel supply system 10P is connected to a pilot manifold 12P that supplies the fuel gas to the pilot nozzle 11P. Further, the pilot fuel supply system 10P is provided with a pilot flow rate regulation valve 13P that controls the flow rate of the fuel gas. The pilot flow rate regulation valve 13P is a valve that regulates the flow rate of the fuel gas supplied to the pilot nozzle 11P. The pilot manifold 12P is configured to distribute the fuel gas supplied from the pilot fuel supply system 10P to the plurality of pilot nozzles 11P.

The top hat fuel supply system 10T is a system that supplies a fuel gas to the top hat nozzle 11T. One end side of the top hat fuel supply system 10T is connected to the fuel gas supply line 15 of the common system 10C, and the other end side of the top hat fuel supply system 10T is connected to a top hat manifold 12T that supplies the fuel gas to the top hat nozzle 11T. Further, the top hat fuel supply system 10T is provided with a top hat flow rate regulation valve 13T that controls the flow rate of the fuel gas. The top hat flow rate regulation valve 13T is a valve that regulates the flow rate of the fuel gas supplied to the top hat nozzle 11T. The top hat manifold 12T is configured to distribute the fuel gas supplied from the top hat fuel supply system 10T to the plurality of top hat nozzles 11T.

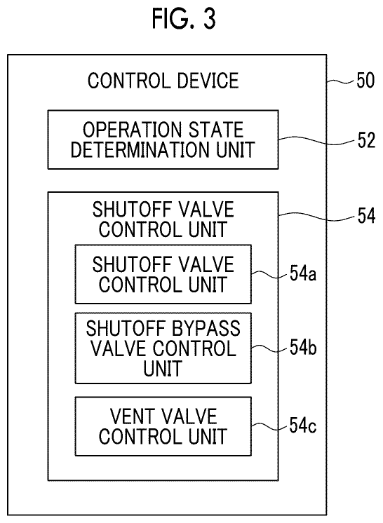

Next, a configuration of the control device 50 for controlling the fuel gas supply device 5 having the above configuration will be described. FIG. 3 is a block diagram showing a functional configuration of the control device 50 in FIG. 1.

For example, the control device 50 is configured to include a central processing unit (CPU), a random access memory (RAM), a read only memory (ROM), and a computer-readable storage medium. A series of processing for realizing various functions is stored in a storage medium or the like in the form of a program, as an example, and the CPU reads out the program to the RAM or the like, and executes processing for information processing and calculation, whereby various functions are realized. A form installed in advance in the ROM or other storage medium, a form provided in a state of being stored in a computer-readable storage medium, or a form of being delivered via wired or wireless communication means may be applied as the program. The computer-readable storage medium is a magnetic disk, a magneto-optical disk, a CD-ROM, a DVD-ROM, a semiconductor memory, or the like.

The control device 50 having such a hardware configuration functions to control each valve of the shutoff valve unit 22 to regulate the upstream pressure of each flow rate regulation valve according to the operation state of the gas turbine power generation plant 1. As a configuration for realizing the function, as shown in FIG. 3, the control device 50 includes an operation state determination unit 52 and a shutoff valve unit control unit 54.

The operation state determination unit 52 is configured to determine the operation state of the gas turbine power generation plant 1. The operation state determination unit 52 can determine the operation state by at least distinguishing between a normal operation state and a non-normal operation state in which the flow rate of the fuel gas to each fuel nozzle is lower compared to the normal operation state. The non-normal operation state includes, for example, the time of ignition or increase in speed of the turbine 4, but may include other operation states.

The shutoff valve unit control unit 54 is configured to control the shutoff valve unit 22. The shutoff valve unit control unit 54 includes a shutoff valve control unit 54a, a shutoff valve bypass valve control unit 54b, and a vent valve control unit 54c for controlling the shutoff valve 24, the shutoff valve bypass valve 26, and the vent valve 19, respectively, which are included in the shutoff valve unit 22.

The shutoff valve control unit 54a is configured to control the shutoff valve 24 in the shutoff valve unit 22. As described above, the shutoff valve 24 is a control valve that can switch between a fully closed state in which the opening degree is 0% and a fully open state in which the opening degree is 100%, and can be switched based on a control signal from the shutoff valve control unit 54a.

The shutoff valve bypass valve control unit 54b is configured to control the shutoff valve bypass valve 26 in the shutoff valve unit 22. As described above, the shutoff valve bypass valve 26 is a control valve in which the opening degree can be regulated from 0% to 100%, and the opening degree is regulated based on a control signal from the shutoff valve bypass valve control unit 54b.

The vent valve control unit 54c is configured to control the vent valve 19 in the shutoff valve unit 22. As described above, the vent valve 19 is a control valve that can switch between a fully closed state in which the opening degree is 0% and a fully open state in which the opening degree is 100%, and can be switched based on a control signal from the vent valve control unit 54c.

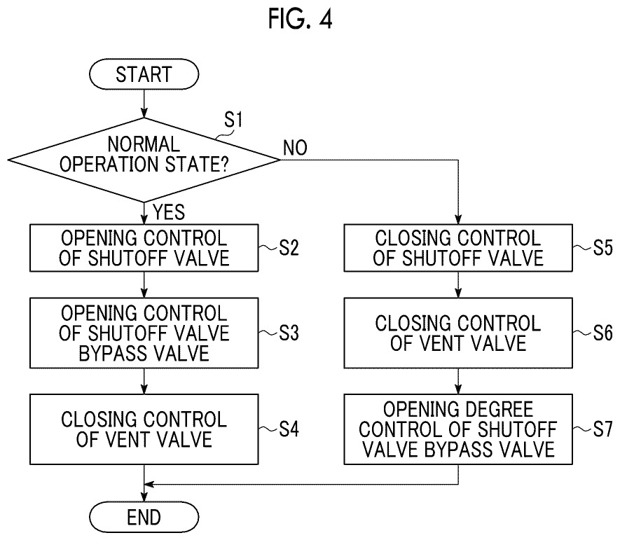

Next, a gas turbine control method performed by the control device 50 having the above-described configuration will be described. FIG. 4 is a flowchart showing the gas turbine control method according to one embodiment.

First, the operation state determination unit 52 determines whether or not the operation state of the gas turbine power generation plant 1 is a normal operation state (step S1). In a case where the operation state is the normal operation state (step S1: YES), the shutoff valve unit control unit 54 controls the shutoff valve 24 to be in an open state and controls the shutoff valve bypass valve 26 and the vent valve 19 to be in a closed state (steps S2 to S4). Accordingly, in the normal operation state, the fuel gas is supplied to each fuel nozzle via the fuel gas supply line 15.

Steps S2 to S4 may be performed in any order.

At this time, the upstream pressure Pin of each flow rate regulation valve depends on the supply pressure of the fuel gas by a fuel gas supply source (not shown) on the upstream side of the fuel gas supply line 15. The upstream pressure Pin is set to satisfy the condition shown in the above equation (1), so that the fuel gas passing through each flow rate regulation valve is in the choke flow region. Therefore, in the normal operation state, the flow rate of the fuel gas passing through each flow rate regulation valve is calculated based on the upstream pressure Pin without depending on the downstream pressure Pout of each flow rate regulation valve. As a result, in the normal operation state, the opening degree control of each flow rate regulation valve can be performed based on the flow rate of the fuel gas calculated based on the upstream pressure Pin.

In this way, in the normal operation state, the fuel gas to each fuel nozzle is supplied via the fuel gas supply line 15 provided with the shutoff valve 24. In the non-normal operation state in which the flow rate of the fuel gas is relatively low compared to the normal operation state, if the same fuel gas supply path as in the normal operation state is taken, there is a concern that the flow rate coefficient (Cv value) of each flow rate regulation valve may decrease and the accuracy of the flow rate control of the fuel gas may decrease. Therefore, in a case where it is determined that the operation state is the non-normal operation state (step S1: NO), the shutoff valve unit control unit 54 controls the shutoff valve 24 and the vent valve 19 to be in a fully closed state, controls the shutoff valve bypass valve 26 to be in an open state, and controls the opening degree of each flow rate regulation valve within a range in which the fuel gas passing through each flow rate regulation valve can be maintained in the choke flow region (steps S5 to S7). At this time, the opening degree of the shutoff valve bypass valve 26 is controlled such that the upstream pressure of each flow rate regulation valve is lower compared to the normal operation state. The shutoff valve bypass valve 26 is a so-called small valve configured to have a smaller flow path cross-sectional area than the shutoff valve 24. Therefore, by changing the path of the fuel gas in the shutoff valve unit 22 in this way, it is possible to obtain control stability by appropriately securing the flow rate coefficient of each flow rate regulation valve while maintaining the fuel gas passing through each flow rate regulation valve in the choke flow region even in the non-normal operation state in which the flow rate of the fuel gas is reduced.

Steps S5 to S7 may be performed in any order.

In the embodiment shown in FIG. 4, in order to facilitate the description, in step S1, only determining whether or not the operation state is the normal operation state is performed as the determination of the operation state. However, the operation state determination unit 52 may independently determine whether or not the operation state is an abnormality occurrence state in which some abnormality has occurred in the gas turbine power generation plant 1. In this case, when it is determined that the operation state is the abnormality occurrence state, the shutoff valve 24 and the shutoff valve bypass valve 26 are controlled to be closed, and the vent valve 19 is controlled to be opened. In this manner, the fuel gas flowing through the fuel gas supply line 15 is shut off, and the shut-off fuel gas can be discharged to the outside via the fuel gas discharge line 18.

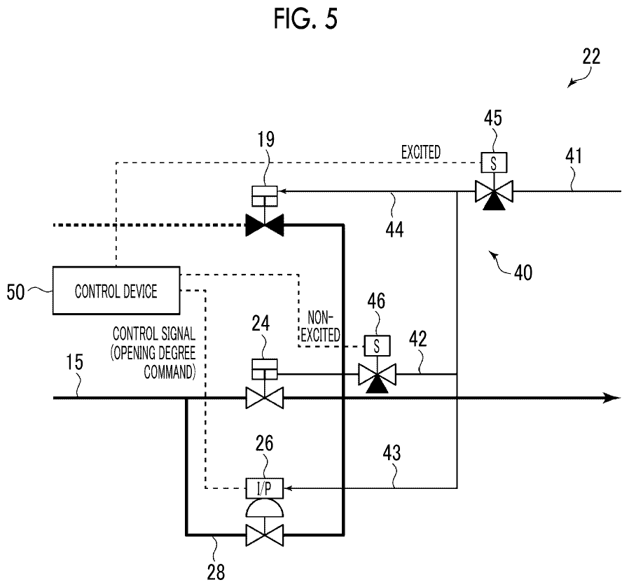

Next, a specific configuration of the shutoff valve unit 22 will be described. FIG. 5 is a schematic configuration diagram of the shutoff valve unit 22 in FIG. 2.

The shutoff valve unit 22 is configured as a unit in which the shutoff valve 24, the shutoff valve bypass valve 26, and the vent valve 19 described above can be interlocked and operated. The shutoff valve 24, the shutoff valve bypass valve 26, and the vent valve 19 are all air drive valves that can be operated by control air supplied from a control air supply system 40. In particular, while the shutoff valve 24 and the vent valve 19 are configured to be selectively switched between the fully open state and the fully closed state in response to the presence or absence of the supply of the control air, the shutoff valve bypass valve 26 is configured as a control valve capable of performing the opening degree control based on the control signal from the control device 50 in addition to the control air supplied from the control air supply system 40.

The control air supply system 40 includes a control air main line 41 having one end connected to a control air supply source (not shown), and a first control air branch line 42, a second control air branch line 43, and a third control air branch line 44 that branch from the other end of the control air main line 41 and are connected to the shutoff valve 24, the shutoff valve bypass valve 26, and the vent valve 19, respectively.

The control air main line 41 is provided with a first solenoid valve 45 that can be opened and closed by being excited based on a control signal from the control device 50. In the present embodiment, in particular, the first solenoid valve 45 is configured to be in an open state when excited and to be in a closed state when not excited. In addition, the first control air branch line 42 is provided with a second solenoid valve 46 that can be opened and closed by being excited based on a control signal from the control device 50. In the present embodiment, in particular, the second solenoid valve 46 is configured to be in a closed state when excited and to be in an open state when not excited, in contrast to the first solenoid valve 45 described above.

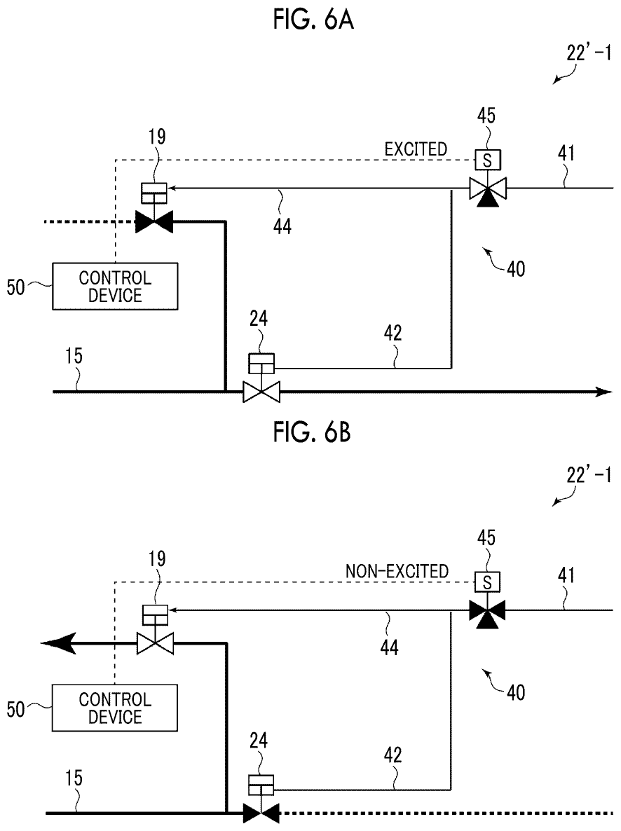

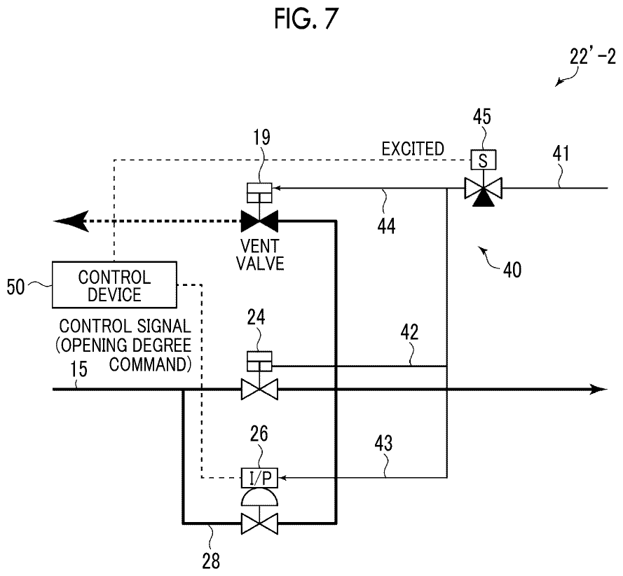

Here, as a premise technique for understanding the characteristics of the shutoff valve unit 22 having such a configuration, some reference techniques will be described. FIGS. 6A and 6B are configuration diagrams of a shutoff valve unit 22′-1 according to a first reference technique, and FIG. 7 is a configuration diagram of a shutoff valve unit 22′-2 according to a second reference technique.

In the reference techniques, the configurations corresponding to the above-described embodiment are denoted by common reference numerals, and the overlapping description will be omitted unless otherwise specified.

First, in the first reference technique shown in FIGS. 6A and 6B, a simple configuration having the shutoff valve bypass valve 26 and a peripheral configuration thereof omitted is adopted as compared to the above-described embodiment. In this configuration, in a normal operation state in which no abnormality has occurred, as shown in FIG. 6A, the shutoff valve 24 is in an open state and the vent valve 19 is in a closed state. In this manner, the fuel gas is supplied to each flow rate regulation valve on the downstream side via the fuel gas supply line 15. On the other hand, when an abnormality has occurred, as shown in FIG. 6B, the shutoff valve 24 is in a closed state and the vent valve 19 is in an open state. In this manner, the fuel gas shut off by the shutoff valve 24 is discharged to the outside via the vent valve 19.

In this way, in the first reference technique, the shutoff valve 24 and the vent valve 19 have a relationship in which the open/closed states are operated in a reverse manner to each other. In a case where independent control air supply systems are provided for the shutoff valve 24 and the vent valve 19, respectively, if one control air supply system does not operate normally due to a failure or the like of a solenoid valve, the shutoff valve 24 and the vent valve 19 that should originally operate in a reverse manner may operate in the same manner (for example, both are in an open state or a closed state), and thus the fuel gas may flow in an unintended manner, which poses a risk from the viewpoint of apparatus protection and safety.

Therefore, in FIG. 6, the shutoff valve 24 and the vent valve 19 have a common control air supply system 40, and are configured to operate in a reverse manner with respect to the supply of the control air, thereby reducing such a risk. That is, the shutoff valve 24 is configured to be in the open state when the control air is supplied, whereas the vent valve 19 is configured to be in the closed state when the control air is supplied. In this manner, the opening and closing operations of the shutoff valve 24 and the vent valve 19 at the time of the occurrence of the abnormality can be realized with a simple configuration while effectively suppressing the above-described risk.

Next, in the second reference technique shown in FIG. 7, the shutoff valve bypass valve 26 and a peripheral configuration thereof are added based on the first reference technique. In the second reference technique, the control air from the control air main line 41 is configured to be directly supplied to the shutoff valve 24, the shutoff valve bypass valve 26, and the vent valve 19. In this case, when the shutoff valve 24 and the shutoff valve bypass valve 26 and the vent valve 19 are configured to operate in a reverse manner to each other according to the first reference technique described above at the time of the occurrence of the abnormality, in a case where the flow rate of the fuel gas is low as described above, such as at the time of ignition or increase in speed, it is not possible to cope with the opening degree control of the shutoff valve bypass valve 26 instead of the shutoff valve 24. For example, as shown in FIG. 7, when control air is supplied to the shutoff valve bypass valve 26 in order to perform the opening degree control by the shutoff valve bypass valve 26, the control air is also supplied to the shutoff valve 24. Therefore, it is not possible to structurally perform an operation of the opening degree control of the shutoff valve bypass valve 26 while the shutoff valve 24 and the vent valve 19 are in a closed state.

Such a problem can be suitably solved by the shutoff valve unit 22 according to the present embodiment shown in FIG. 5. In the shutoff valve unit 22, the second solenoid valve 46 is provided on the first control air branch line 42 connected to the shutoff valve 24, compared to the second reference technique. In this manner, with respect to the supply of the control air, the shutoff valve 24 and the shutoff valve bypass valve 26 and the vent valve 19 operate in a reverse manner to each other by the control air from the common control air supply system 40, and in a case where the flow rate of the fuel gas is low, such as at the time of ignition or increase in speed, the opening degree control by the shutoff valve bypass valve 26 can be realized while the shutoff valve 24 is in a closed state.

Specifically, first, in FIG. 5, an operation state of the shutoff valve unit 22 during normal operation is shown. In this case, the first solenoid valve 45 is brought into an open state by being excited by a control signal from the control device 50. Accordingly, the control air from the control air supply source (not shown) is supplied from the control air main line 41 via the first control air branch line 42, the second control air branch line 43, and the third control air branch line 44. Here, the first control air branch line 42 is provided with the second solenoid valve 46, but the second solenoid valve 46 is brought into an open state by not being excited by the control signal from the control device 50.

In addition, since the second control air branch line 43 is directly connected to the shutoff valve bypass valve 26, the control air is supplied to the shutoff valve bypass valve 26, so that the opening degree is variable. However, the opening degree of the shutoff valve bypass valve 26 is controlled to 0% (that is, a closed state) by the control signal from the control device 50. In addition, since the third control air branch line 44 is directly connected to the vent valve 19, the control air is supplied to the vent valve 19, so that the vent valve 19 is brought into a closed state.

In this way, in the normal operation state, the shutoff valve unit 22 brings the shutoff valve 24 into an open state and brings the shutoff valve bypass valve 26 and the vent valve 19 into a closed state, so that the supply of the fuel gas via the fuel gas supply line 15 is possible. In addition, the normal operation state occupies a longer period compared to other states (for example, a non-normal operation state or an abnormality occurrence state) during the operation of the gas turbine power generation plant 1. Therefore, by bringing the second solenoid valve 46 into a non-excited state in the normal operation state, the risk of a failure occurring in the second solenoid valve 46 can be effectively reduced.

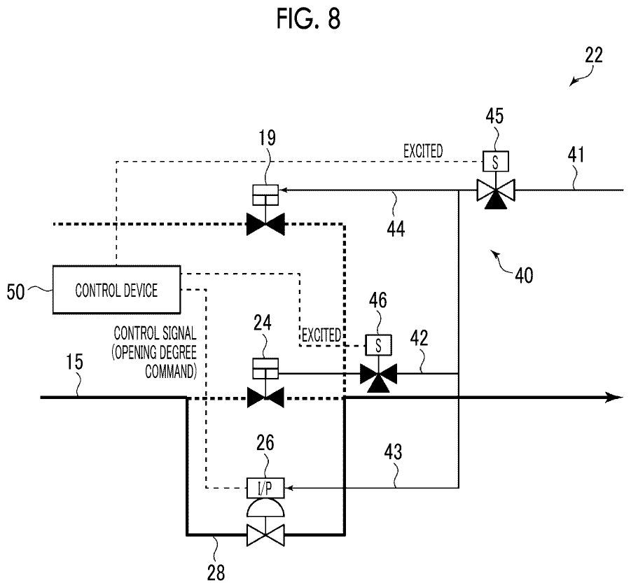

FIG. 8 is a schematic diagram showing an operation state of the shutoff valve unit 22 in FIG. 5 in a non-normal operation state (for example, at the time of ignition or increase in speed). In the non-normal operation state, the first solenoid valve 45 is brought into an open state by being excited by the control signal from the control device 50. Accordingly, the control air from the control air supply source (not shown) is supplied from the control air main line 41 via the first control air branch line 42, the second control air branch line 43, and the third control air branch line 44. Here, the first control air branch line 42 is provided with the second solenoid valve 46, and the second solenoid valve 46 is brought into a closed state by being excited by the control signal from the control device 50. As a result, the control air is not supplied to the shutoff valve 24, so that the shutoff valve 24 is brought into a closed state.

In addition, since the second control air branch line 43 is directly connected to the shutoff valve bypass valve 26, the control air is supplied to the shutoff valve bypass valve 26, so that the opening degree is variable, and the opening degree is controlled in a variable manner by the control signal from the control device 50. In addition, since the third control air branch line 44 is directly connected to the vent valve 19, the control air is supplied to the vent valve 19, so that the vent valve 19 is brought into a closed state.

In this way, in the non-normal operation state, the opening degree control of the shutoff valve bypass valve 26, which is the control valve, can be performed by the control signal from the control device 50 in a state in which both the shutoff valve 24 and the vent valve 19 are closed.

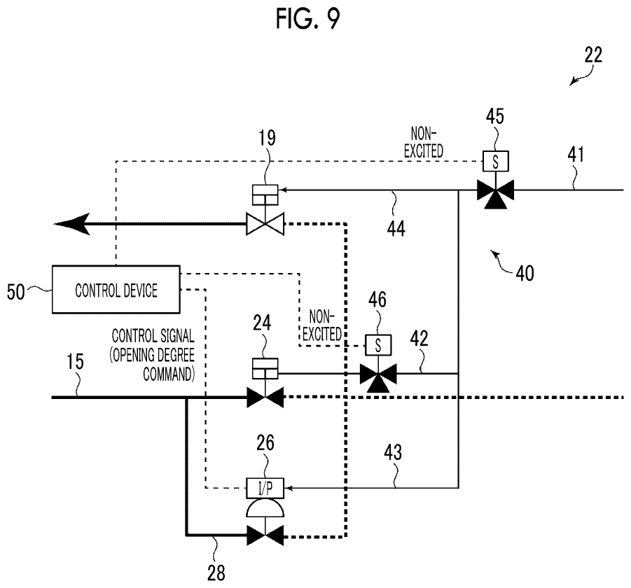

FIG. 9 is a schematic diagram showing an operation state of the shutoff valve unit 22 in FIG. 5 in an abnormality occurrence state. In the abnormality occurrence state, the first solenoid valve 45 is brought into a closed state by not being excited by the control signal from the control device 50. In this manner, the control air from the control air supply source (not shown) is shut off in the control air main line 41. As a result, the shutoff valve 24 is brought into a closed state because the control air is not supplied from the first control air branch line 42, and the fuel gas in the fuel gas supply line 15 is shut off.

The first control air branch line 42 is provided with the second solenoid valve 46, but the configuration is such that the control air is not supplied to the shutoff valve 24 regardless of the open/closed states of the second solenoid valve 46. Therefore, even if the second solenoid valve 46 is malfunctioning, the fuel gas of the fuel gas supply line 15 can be reliably shut off, and a design on the safe side can be made.

In addition, since the control air is not supplied to the shutoff valve bypass valve 26 from the second control air branch line 43, the shutoff valve bypass valve 26 is brought into a closed state. In addition, since the control air is not supplied to the vent valve 19 via the third control air branch line 44, the vent valve 19 is brought into an open state, and the fuel gas shut off by the shutoff valve 24 is discharged to the outside via the vent valve 19.

In this way, in a case where an abnormality has occurred, the shutoff valve 24 and the shutoff valve bypass valve 26 are brought into a closed state, so that the fuel gas can be shut off for each fuel nozzle, and the vent valve 19 is brought into an open state, so that the shut-off fuel gas can be discharged to the outside.

In addition, it is possible to appropriately replace the components in the embodiment described above with well-known components within the scope which does not depart from the gist of the present disclosure, and the embodiments described above may be combined appropriately.

For example, contents described in each of the above-described embodiments are understood as follows.

(1) A fuel gas supply device according to one aspect is
a fuel gas supply device for supplying a fuel gas to a plurality of fuel nozzles provided in a combustor of a gas turbine, the fuel gas supply device including:
a fuel gas supply system for supplying the fuel gas to each of the plurality of fuel nozzles via a fuel gas supply line connected to a fuel gas supply source;
a plurality of flow rate regulation valves provided in the fuel gas supply line and for regulating a flow rate of the fuel gas to each of the plurality of fuel nozzles;
a shutoff valve provided on an upstream side of the plurality of flow rate regulation valves in the fuel gas supply line;
a bypass line provided to bypass the shutoff valve with respect to the fuel gas supply line;
a shutoff valve bypass valve provided in the bypass line; and
a control device for controlling an upstream pressure of the plurality of flow rate regulation valves in the fuel gas supply line, in which
the control device
   controls the upstream pressure using a supply pressure of the fuel gas supply source by opening the shutoff valve and closing the shutoff valve bypass valve in a case where the gas turbine is in a normal operation state, and
   controls the upstream pressure to be lower compared to the normal operation by closing the shutoff valve and opening the shutoff valve bypass valve in a non-normal operation state including at least one of the time of ignition or increase in speed of the gas turbine.

According to the aspect of the above (1), in the normal operation state of the gas turbine, the fuel gas is supplied to the plurality of fuel nozzles via the shutoff valve by opening the shutoff valve and closing the shutoff valve bypass valve. At this time, the upstream pressure of the flow rate regulation valve is controlled using the supply pressure of the fuel gas supply source. On the other hand, in the non-normal operation state including at least one of the time of ignition or increase in speed of the gas turbine, the fuel gas is supplied to the plurality of fuel nozzles via the shutoff valve bypass valve by closing the shutoff valve and opening the shutoff valve bypass valve. At this time, the upstream pressure of the flow rate regulation valve is controlled to be lower compared to the normal operation. Accordingly, even in the non-normal operation state such as at the time of ignition or increase in speed, in which the required fuel gas flow rate of the gas turbine is lower compared to the normal operation state, the flow rate coefficient of the flow rate regulation valve can be appropriately secured.

(2) In another aspect according to the aspect of the above (1),
the shutoff valve bypass valve is a control valve capable of regulating an opening degree, and
the control device controls the opening degree of the shutoff valve bypass valve such that the upstream pressure is lower in the non-normal operation state compared to the normal operation state.

According to the aspect of the above (2), even in the non-normal operation state such as at the time of ignition or increase in speed, in which the required fuel gas flow rate of the gas turbine is lower compared to the normal operation state, the flow rate coefficient of the flow rate regulation valve can be appropriately secured by the opening degree control of the shutoff valve bypass valve.

(3) In still another aspect according to the aspect of the above (1) or (2),
the control device controls the upstream pressure such that the plurality of flow rate regulation valves operate in a choke flow state.

According to the aspect of the above (3), the upstream pressure of the flow rate regulation valve is controlled such that the flow rate regulation valve operates in the choke flow region. Accordingly, it is not necessary to calculate the downstream pressure of the flow rate regulation valve, and the flow rate control of the fuel gas can be performed for each fuel nozzle with a simple configuration.

(4) In still another aspect according to any one aspect of the above (1) to (3),
the fuel gas supply system includes a plurality of fuel gas branch lines that branch from a downstream side of the fuel gas supply line to the plurality of fuel nozzles,
the shutoff valve is provided in the fuel gas supply line, and
the plurality of flow rate regulation valves are respectively provided in the plurality of branch fuel gas supply lines.

According to the aspect of the above (4), the fuel gas from the fuel gas supply source is supplied to each fuel nozzle via the plurality of branch fuel gas supply lines branching from the fuel gas supply line. In such a fuel gas supply system, the shutoff valve is provided in the fuel gas supply line, and the plurality of flow rate regulation valves are respectively provided in the plurality of branch fuel gas supply lines.

(5) In still another aspect according to any one aspect of the above (1) to (4), the fuel gas supply device further includes:
a fuel gas discharge line for discharging the fuel gas of the fuel gas supply line shut off by the shutoff valve to an outside; and
a vent valve provided in the fuel gas discharge line, in which
the shutoff valve, the shutoff valve bypass valve, and the vent valve are air drive valves capable of being operated by control air supplied from a common control air supply system.

According to the aspect of the above (5), the fuel gas supply line constituting the fuel gas supply system is provided with, for example, a vent valve for discharging the fuel gas to the outside (for example, the atmosphere) in a case where the fuel gas flowing through the fuel gas supply line is shut off by the shutoff valve when an abnormality has occurred. The vent valve is configured as an air drive valve together with the shutoff valve and the shutoff valve bypass valve described above. The air drive valve is cost-effective compared to a hydraulic drive valve that includes a hydraulic system. In addition, the shutoff valve, the shutoff valve bypass valve, and the vent valve, which are air drive valves, can be opened and closed by being operated by the control air supplied from a common air supply system. In this way, by providing the common air supply system for supplying the control air to the shutoff valve, the shutoff valve bypass valve, and the vent valve, the configuration can be made efficient, and the installation space and the cost can be effectively suppressed.

(6) In still another aspect according to the aspect of the above (5),
the shutoff valve and the shutoff valve bypass valve are in a closed state when the control air is shut off, and
the vent valve is in an open state when the control air is shut off.

According to the aspect of the above (6), in a case where the open/closed states are controlled by the control air supplied from the common air supply system provided to the shutoff valve bypass valve in addition to the shutoff valve and the vent valve, when some abnormality has occurred, the control air is shut off, so that the shutoff valve and the shutoff valve bypass valve can be brought into a closed state to shut off the fuel gas, and the vent valve can be brought into an open state to allow the shut-off fuel gas to discharge to the outside.

(7) In still another aspect according to the aspect of the above (5) or (6),
the air supply system includes
   a control air supply line for supplying the control air,
   a plurality of control air branch lines that branch from the control air supply line and are connected to the shutoff valve, the shutoff valve bypass valve, and the vent valve, respectively,
   a first solenoid valve provided in the control air supply line, and
   a second solenoid valve provided in the control air branch line connected to the shutoff valve.

Here, in the air supply system not including the shutoff valve bypass valve but including the shutoff valve and the vent valve, in a case where the fuel gas in the fuel gas supply system is shut off by the occurrence of some abnormality in the gas turbine, the shutoff valve is closed to shut off the fuel gas flowing through the fuel gas supply line, and the vent valve is opened to discharge the shut-off fuel gas to the outside. In this case, if solenoid valves for switching the supply/shut-off of the control air to the shutoff valve and the vent valve are independently provided, in a case where one solenoid valve does not operate normally due to a failure or the like, the control air may flow in an unintended manner, which may pose a risk from the viewpoint of device protection or safety. Therefore, by sharing the solenoid valve for supplying/shutting off the control air with respect to the shutoff valve and the vent valve and configuring the shutoff valve and the vent valve to be reversed in opening and closing with respect to the supply/shut-off of the control air, the reliability of the closing operation of the shutoff valve and the opening operation of the vent valve can be improved when an abnormality has occurred while reducing the risk of failure and costs by reducing the number of solenoid valves.

In the aspect of the above (7), the first solenoid valve is provided in the control air supply line. In this manner, as in the reference technique, opening and closing of the shutoff valve and the vent valve are operated in a reverse manner to each other when an abnormality has occurred by opening and closing the first solenoid valve, so that the risk of failure of the solenoid valve can be effectively reduced. On the other hand, by providing the second solenoid valve in the control air branch line connected to the shutoff valve, it is possible to perform the opening degree control of the shutoff valve bypass valve while closing the shutoff valve and the vent valve in the non-normal operation state such as at the time of ignition or increase in speed of the gas turbine described above. With such a configuration, it is possible to realize the opening control of the shutoff valve bypass valve in the non-normal operation state such as at the time of ignition or increase in speed of the gas turbine while suppressing the number of solenoid valves included in the control air supply system.

(8) In still another aspect according to the aspect of the above (7),
the first solenoid valve is brought into an open state when excited, and
the second solenoid valve is brought into a closed state when excited.

According to the aspect of the above (8), in the normal operation state of the gas turbine, the shutoff valve needs to be in an open state because the fuel gas is not shut off and the second solenoid valve is brought into a non-excited state. In this manner, by not exciting the second solenoid valve in the normal operation state that accounts for a large part during the operation of the gas turbine (that is, by reducing the excitation period of the second solenoid valve), the possibility of a failure occurring in the second solenoid valve can be reduced, and reliability can be improved.

### REFERENCE SIGNS LIST

1: gas turbine power generation plant
2: compressor
3: combustor
4: turbine
5: fuel gas supply device
6: generator
7: rotary shaft
10C: common system
10M1: first main fuel supply system
10P: pilot fuel supply system
10T: top hat fuel supply system
11M1: first main nozzle
11P: pilot nozzle
11T: top hat nozzle
12M1: first main manifold
12P: pilot manifold
12T: top hat manifold
13M1: first main flow rate regulation valve
13P: pilot flow rate regulation valve
13T: top hat flow rate regulation valve
15: fuel gas supply line
18: fuel gas discharge line
19: vent valve
20: pressure sensor
22: shutoff valve unit
24: shutoff valve
26: shutoff valve bypass valve
28: bypass line
40: control air supply system
41: control air main line
42: first control air branch line
43: second control air branch line
44: third control air branch line
45: first solenoid valve
46: second solenoid valve
50: control device
52: operation state determination unit
54: shutoff valve unit control unit
54a: shutoff valve control unit
54b: shutoff valve bypass valve control unit
54c: vent valve control unit

1. A fuel gas supply device for supplying a fuel gas to a plurality of fuel nozzles provided in a combustor of a gas turbine, the fuel gas supply device comprising:
a fuel gas supply system for supplying the fuel gas to each of the plurality of fuel nozzles via a fuel gas supply line connected to a fuel gas supply source;
a plurality of flow rate regulation valves provided in the fuel gas supply line and for regulating a flow rate of the fuel gas to each of the plurality of fuel nozzles;
a shutoff valve provided on an upstream side of the plurality of flow rate regulation valves in the fuel gas supply line;
a bypass line provided to bypass the shutoff valve with respect to the fuel gas supply line;
a shutoff valve bypass valve provided in the bypass line; and
a control device for controlling an upstream pressure of the plurality of flow rate regulation valves in the fuel gas supply line, wherein
the control device
controls the upstream pressure using a supply pressure of the fuel gas supply source by opening the shutoff valve and closing the shutoff valve bypass valve in a case where the gas turbine is in a normal operation state, and
controls the upstream pressure to be lower compared to the normal operation by closing the shutoff valve and opening the shutoff valve bypass valve in a non-normal operation state including at least one of the time of ignition or increase in speed of the gas turbine.

2. The fuel gas supply device according to claim 1, wherein
the shutoff valve bypass valve is a control valve capable of regulating an opening degree, and
the control device controls the opening degree of the shutoff valve bypass valve such that the upstream pressure is lower in the non-normal operation state compared to the normal operation state.

3. The fuel gas supply device according to claim 1, wherein
the control device controls the upstream pressure such that the plurality of flow rate regulation valves operate in a choke flow state.

4. The fuel gas supply device according to claim 1, wherein
the fuel gas supply system includes a plurality of fuel gas branch lines that branch from a downstream side of the fuel gas supply line to the plurality of fuel nozzles,
the shutoff valve is provided in the fuel gas supply line, and
the plurality of flow rate regulation valves are respectively provided in the plurality of branch fuel gas supply lines.

5. The fuel gas supply device according to claim 1, further comprising:
a fuel gas discharge line for discharging the fuel gas of the fuel gas supply line shut off by the shutoff valve to an outside; and
a vent valve provided in the fuel gas discharge line, wherein
the shutoff valve, the shutoff valve bypass valve, and the vent valve are air drive valves capable of being operated by control air supplied from a common control air supply system.

6. The fuel gas supply device according to claim 5, wherein
the shutoff valve and the shutoff valve bypass valve are in a closed state when the control air is shut off, and
the vent valve is in an open state when the control air is shut off.

7. The fuel gas supply device according to claim 6, wherein
the air supply system includes
a control air supply line for supplying the control air,
a plurality of control air branch lines that branch from the control air supply line and are connected to the shutoff valve, the shutoff valve bypass valve, and the vent valve, respectively,
a first solenoid valve provided in the control air supply line, and
a second solenoid valve provided in the control air branch line connected to the shutoff valve.

8. The fuel gas supply device according to claim 7, wherein
the first solenoid valve is brought into an open state when excited, and
the second solenoid valve is brought into a closed state when excited.
